(19) United States
(12) Patent Application Publication
(10) Pub. No.: US 2025/0007235 A1
(43) Pub. Date: Jan. 2, 2025

(54) HYPER-RADIANCE LASER GENERATION SYSTEM AND HYPER-RADIANCE LASER GENERATION METHOD

(71) Applicant: Seoul National University R&DB Foundation, Seoul (KR)

(72) Inventors: Kyungwon AN, Seoul (KR); Junseok HAN, Pyeongtaek-si, Gyeonggi-do (KR); Jinuk KIM, Seoul (KR); Seunghoon OH, Seoul (KR); Gibeom SON, Seoul (KR); Junseo HA, Seoul (KR)

(73) Assignee: Seoul National University R&DB Foundation, Seoul (KR)

(21) Appl. No.: 18/694,959

(22) PCT Filed: Jul. 5, 2022
(86) PCT No.: PCT/KR2022/009643

§ 371 Date: Mar. 23, 2024

(30) Foreign Application Priority Data
Sep. 24, 2021 (KR) 10-2021-0126662

(51) Int. Cl. H01S 3/16; H01S 3/094

(52) U.S. Cl. CPC H01S 3/16; H01S 3/094

(57) ABSTRACT

Hyper-radiance laser generation systems and hyper-radiance laser generation methods are disclosed. A disclosed hyper-radiance laser generation system may include a laser resonator including first and second mirror members arranged to face each other, a nanohole defining member disposed on one side of the laser resonator and where at least one nanohole opened toward an internal space between the first and second mirror members is formed, an atomic beam irradiance member which irradiates a plurality of atoms so that they may pass through the nanohole and into the internal space, a first laser pump which generates a first laser beam to be irradiated to the plurality of atoms in any one of a region between the atomic beam irradiance member and the nanohole defining member, and a region between the nanohole defining member and the laser resonator.

### BACKGROUND

### 1. Field

The present invention relates to a light generation system and a light generation method, and more particularly, to a laser generation system and a laser generation method.

### 2. Description of the Related Art

In the existing general laser generation, a method for obtaining coherent laser light was used by amplifying light through stimulated emission. In relatively recent years, studies have been conducted to increase the output of stimulated emission by using super-radiance as a next step to conventional lasers.

The super-radiance of a laser refers to a phenomenon that when atoms are quantumly related, and a laser having an emission intensity which is stronger than the emission intensity simply proportional to the number of atoms due to the quantum effect, that is, an emission intensity proportional to the square of the number of atoms may be obtained. For a considerable period of time, super-radiance was considered as the limit of emission intensity, but several studies have shown that the limit of super-radiance may be exceeded, and the emission phenomenon exceeding that limit is named as hyper-radiance.

However, hyper-radiance studies conducted so far have the problem that although the laser emission intensity exceeds the intensity proportional to the square of the number of atoms, the emission intensity itself is not remarkably stronger than the limit of hyper-radiance. Furthermore, in the case of the existing hyper-radiance devices, there is a disadvantage in that technological implementation is not easy because a trap is used to fix atoms or materials inside the resonator.

Therefore, it is required to develop a new hyper-radiance system that may increase the emission intensity and is simpler in technological implementation as compared with the previous hyper-radiance system.

### SUMMARY

The technological object to be achieved by the present invention is to provide a hyper-radiance laser generation system which may increase the intensity of laser emission and is easy to implement technologically.

In addition, the technological object to be achieved by the present invention is to provide a method for generating hyper-radiance laser related to the above-described hyper-radiance laser generating system.

The objects to be achieved by the present invention are not limited to the problems mentioned above, and other objects not mentioned will be understood by those skilled in the art from the description below.

According to one embodiment of the present invention, there is provided a hyper-radiance laser generation system comprising: a laser resonator including first and second mirror members arranged to face each other; a nanohole defining member disposed on one side of the laser resonator and where at least one nanohole opened toward an internal space between the first and second mirror members is formed; an atomic beam irradiance member which irradiates a plurality of atoms so that they pass through the nanohole and into the internal space; a first laser pump which generates a first laser beam to be irradiated to the plurality of atoms in any one of a region between the atomic beam irradiance member and the nanohole defining member, and a region between the nanohole defining member and the laser resonator; and a second laser pump which generates a second laser beam that overlaps with a resonator internal field formed between the first and second mirror members and is irradiated to the plurality of atoms passing through the resonator internal field. The laser resonator, the first laser beam, and the second laser beam may achieve a resonance state.

A center of the second laser beam may overlap with the resonator internal field.

The plurality of atoms may be irradiated in a direction perpendicular to an axis of the laser resonator.

The first laser beam may be irradiated to a direction perpendicular to a direction in which the plurality of atoms travel.

The second laser beam may be irradiated to a direction perpendicular to both of a direction in which the plurality of atoms travel, and an axis of the laser resonator.

The nanohole may be disposed at a position corresponding to an antinode of the resonator internal field.

The first laser pump may be provided to irradiate the first laser beam between the atomic beam irradiance member and the nanohole defining member.

The first laser pump may be provided to irradiate the first laser beam between the nanohole defining member and the laser resonator.

An emitting laser emitted from the laser resonator may have an emission intensity larger than an emission intensity proportional to a square of a number of atoms passing through the resonator internal field.

According to another embodiment of the present invention, there is provided a method for generating a hyper-radiance laser comprising: preparing a laser resonator including first and second mirror members arranged to face each other; disposing a nanohole defining member having at least one nanohole opened toward an internal space between the first and second mirror members on one side of the laser resonator; irradiating a plurality of atoms so that they pass through the nanohole into the internal space by using an atomic beam irradiance member disposed spaced apart from the laser resonator with the nanohole defining member interposed therebetween; irradiating a first laser beam to the plurality of atoms in any one of a region between the atomic beam irradiance member and the nanohole defining member, and a region between the nanohole defining member and the laser resonator; irradiating a second laser beam to the plurality of atoms passing through a resonator internal field so as to overlap the resonator internal field formed between the first and second mirror members; and emitting light resonating in the internal space of the laser resonator in an axial direction of the laser resonator as a form of a laser. The laser resonator, the first laser beam, and the second laser beam may achieve a resonance state.

A center of the second laser beam may overlap with the resonator internal field.

The plurality of atoms may be irradiated to a direction perpendicular to an axis of the laser resonator.

The first laser beam may be irradiated to a direction perpendicular to a direction in which the plurality of atoms travel.

The second laser beam may be irradiated to a direction perpendicular to both of a direction in which the plurality of atoms travel, and an axis of the laser resonator.

The nanohole may be disposed at a position corresponding to an antinode of the resonator internal field.

According to embodiments of the present invention, a hyper-radiance laser generation system having an emission intensity larger than the emission intensity proportional to the square of the number of atoms may be implemented through the arrangement of the laser resonator and the laser pumps. In the hyper-radiance laser generation system according to the embodiment, since an intensity component proportional to the cube of the number of atoms is added, it is possible to generate a laser having an emission intensity remarkably larger than that of the existing super-radiance.

In addition, according to embodiments of the present invention, there is an advantage in that technological implementation is easy because a hyper-radiance system with a relatively simple structure is used without using a trap for fixing atoms inside the laser resonator. In addition, there is an advantage that hyper-radiance may be implemented in a relatively simple manner through simple addition and modification of configuration in a system that uses an existing laser or super-radiance laser.

The hyper-radiance laser generation system and hyper-radiance laser generation method according to embodiments may be usefully applied to various fields such as quantum information, optical communication, and laser processing which require high-efficiency, and high-output lasers.

### BRIEF DESCRIPTION OF THE DRAWINGS

FIG. 1 is a diagram showing a hyper-radiance laser generation system according to an embodiment of the present invention.

FIG. 2 is a diagram showing a hyper-radiance laser generation system according to another embodiment of the present invention.

FIG. 3 is a flowchart for explaining a method for generating a hyper-radiance laser according to an embodiment of the present invention.

FIG. 4 is a graph showing simulation results evaluating the dependence of hyper-radiance on g/κ and Δ/κ in a hyper-radiance laser generation system according to an embodiment of the present invention.

FIG. 5 is a graph showing simulation results evaluating the dependence of hyper-radiance on g/κ and Ω/κ in a hyper-radiance laser generation system according to an embodiment of the present invention.

FIG. 6 is a graph showing an origin of hyper-radiance with regard to resonance which may be obtained in connection with a hyper-radiance laser generation system according to an embodiment of the present invention.

FIG. 7 is a graph evaluating the change in average photon number inside the resonator which may be obtained from a hyper-radiance laser generation system according to an embodiment of the present invention.

FIG. 8 is a graph showing simulation results evaluating whether or not hyper-radiance exists for a hyper-radiance laser generation system according to an embodiment of the present invention.

### DETAILED DESCRIPTION

Hereinafter, embodiments of the present invention will be described in detail with reference to the accompanying drawings.

The embodiments of the present invention to be described below are provided to more clearly explain the present invention to those skilled in the art, and the scope of the present invention is not limited by the following embodiments, and the embodiments may be modified in many different forms.

The terms used in this specification are used to describe specific embodiments and are not intended to limit the present invention. The terms indicating a singular form used herein may include plural forms unless the context clearly indicates otherwise. Also, as used herein, the terms, “comprise” and/or “comprising” specify the presence of the stated shape, step, number, operation, member, element, and/or group thereof and does not exclude the presence or addition of one or more other shapes, steps, numbers, operations, elements, elements and/or groups thereof. In addition, the term, “connection” used in this specification means not only a direct connection of certain members, but also a concept including an indirect connection in which other members are interposed between the members.

In addition, in the present specification, when a member is said to be located “on” another member, this arrangement includes not only a case in which a member is in contact with another member, but also a case where another member exists between the two members. As used herein, the term, “and/or” includes any one and all combinations of one or more of the listed items. In addition, the terms of degree such as “about” and “substantially” used in the present specification are used as a range of values or degrees, or as a meaning close thereto, taking into account inherent manufacturing and material tolerances, and exact or absolute figures provided to aid in the understanding of this application are used to prevent the infringers from unfairly exploiting the stated disclosure.

Hereinafter, embodiments of the present invention will be described in detail with reference to the accompanying drawings. A size or a thickness of areas or parts shown in the accompanying drawings may be slightly exaggerated for clarity of the specification and convenience of description. The same reference numbers indicate the same configuring elements throughout the detailed description.

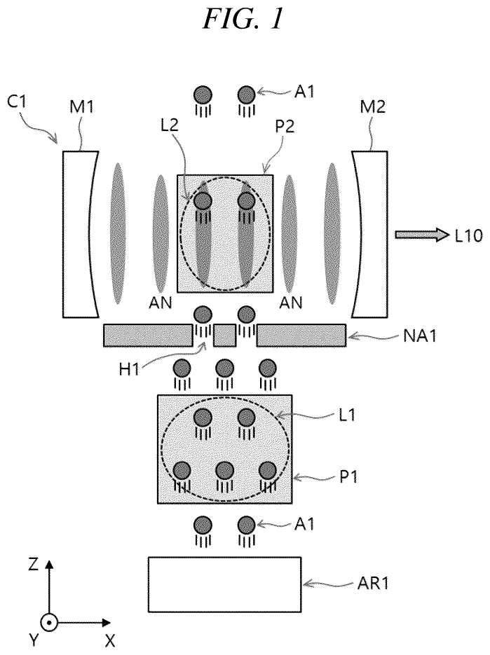

FIG. 1 is a diagram showing a hyper-radiance laser generation system according to an embodiment of the present invention.

Referring to FIG. 1, the hyper-radiance laser generation system according to an embodiment of the present invention may include a laser resonator C1 including first and second mirror members M1, M2 arranged to face each other. The laser resonator C1 may also be referred to as a ‘laser cavity’ or a ‘laser cavity structure’.

The hyper-radiance laser generation system may include a nanohole defining member NA1 disposed on one side of the laser resonator C1. The nanohole defining member NA1 may have at least one nanohole H1 opened toward an internal space between the first and second mirror members M1 and M2. A plurality of nanoholes H1 may be formed in the nanohole defining member NA1. The plurality of nanoholes H1 may be arranged regularly to meet predetermined conditions.

In one embodiment, the size of each nanohole H1 may be in the range of 1/100 to ¼ of the laser wavelength. For example, when a laser with a wavelength of 791 nm is applied, each nanohole H1 may have a size of 8 nm to 190 nm. If the size of the nanohole H1 is less than 1/100, the atom diffracts and the progress of the atom which passes through the nanohole H1 may be changed by diffraction, and if the size of the nanohole H1 exceeds ¼, it may be difficult to focus the atoms on the antinode, which will be described later. As a non-limiting example, the size (diameter) of the nanohole H1 may be about 8 to 190 nm, preferably 100 nm to 190 nm, and more preferably 150 nm to 190 nm.

The nanohole defining member NA1 may be referred to as a ‘nanohole array aperture’, a ‘nanolattice array’, or a ‘nanolattice structure’. The nanohole defining member NA1 may be disposed parallel (or substantially parallel) to the axis (i.e., optical axis) of the laser resonator C1. Here, the axis of the laser resonator C1 may correspond to a line connecting the center of the first mirror member M1 and the center of the second mirror member M2. The axis of the laser resonator C1 may be parallel to the X-axis in FIG. 1.

The hyper-radiance laser generation system may include an atomic beam irradiance member AR1 which irradiates a plurality of atoms A1 as a form of a beam so that the plurality of atoms A1 may pass through the plurality of nanoholes H1 and into the internal space of the laser resonator C1. The atomic beam irradiance member AR1 may be, for example, an atomic beam generation oven, and the atomic beam generation oven may be referred to as an ‘atomic oven.’ The plurality of atoms A1 may be, for example, barium atoms. However, the configuration of the atomic beam irradiance member AR1 and the type of atoms A1 are not limited to the above descriptions and may vary in various ways.

The hyper-radiance laser generation system may include a first laser pump P1 which generates a first laser beam L1 irradiated to the plurality of atoms A1 in any one of a region between the atomic beam irradiance member AR1 and the nanohole defining member NA1, and a region between the nanohole defining member NA1 and the laser resonator C1. FIG. 1 shows a case where the first laser beam L1 is irradiated to the plurality of atoms A1 between the atomic beam irradiance member AR1 and the nanohole defining member NA1. It may be said that the first laser beam L1 is irradiated to the plurality of atoms A1 in an area outside the internal space of the laser resonator C1. The first laser pump P1 may be said to be a ‘first laser generator’, and the first laser beam L1 generated by the first laser pump P1 may be said to be a ‘first pump laser beam’. In the drawing, a laser emitter (a first laser emitter) from which the first laser beam L1 is emitted may be disposed between the atomic beam irradiance member AR1 and the nanohole defining member NA1, and the position of the first laser pump P1 is not limited to what is shown and may be changed. A cross-section (a cross-section cut in a width direction) of the first laser beam L1 may have a circular, elliptical, or other shape.

The hyper-radiance laser generation system may further include a second laser pump P2 which generates a second laser beam L2 that overlaps with the resonator internal field formed between the first and second mirror members M1, M2 and is irradiated to the plurality of atoms A1 passing through the resonator internal field. The second laser beam L2 may overlap the resonator internal field and may be irradiated to the plurality of atoms A1 passing through the resonator internal field. Here, the resonator internal field may mean a wave of light resonating between the first and second mirror members M1 and M2. Light resonating between the first and second mirror members M1 and M2 may resonate as a form of a standing wave. Reference numeral AN represents an antinode (i.e., a belly portion of the resonance mode) of the resonator internal field. It may be said that the second laser beam L2 is irradiated to the plurality of atoms A1 in the internal space of the laser resonator C1. The second laser pump P2 may be said to be a ‘second laser generator’, and the second laser beam L2 generated by the second laser pump P2 may be said to be a ‘second pump laser beam’. A laser emitter (a second laser emitter) from which the second laser beam L2 is emitted may be arranged to overlap the resonator internal field, and the position of the second laser pump P2 is not limited to what is shown and may be changed. The cross section (a cross section cut in a width direction) of the second laser beam L2 may have a circular, elliptical, or other shape.

According to an embodiment of the present invention, a center of the second laser beam L2 (i.e., a center of the cross section) may overlap with the resonator internal field. The center of the second laser beam L2 may be placed on or in the vicinity of the axis of the laser resonator C1. Furthermore, the center of the second laser beam L2 may be placed corresponding to the center of the internal space of the laser resonator C1, or may be placed in the vicinity of it. At this time, about 60% or more or about 70% or more of the cross section (cross section cut in a width direction) of the second laser beam L2 may overlap with the resonator internal field. The entire cross section (i.e., 100%) of the second laser beam L2 may overlap with the resonator internal field.

According to an embodiment of the present invention, the plurality of atoms A1 may be irradiated in a direction perpendicular to the axis of the laser resonator C1. The plurality of atoms A1 may be irradiated perpendicular to the axis of the laser resonator C1 from below in the drawing toward the internal space of the laser resonator C1. In the case of FIG. 1, the plurality of atoms A1 may be irradiated to the Z-axis direction. The first laser beam L1 may be irradiated to a direction perpendicular to the direction in which the plurality of atoms A1 travel. Furthermore, the first laser beam L1 may be irradiated to a direction perpendicular to the axis of the laser resonator C1. In the case of FIG. 1, the first laser beam L1 may be irradiated to a direction parallel to the Y-axis. For example, the first laser beam L1 may be irradiated to a direction vertically striking the ground in FIG. 1 or to an opposite direction. The second laser beam L2 may be irradiated to a direction perpendicular to both of the traveling direction of the plurality of atoms A1 and the axis of the laser resonator C1. In the case of FIG. 1, the second laser beam L2 may be irradiated to a direction parallel to the Y-axis. For example, the second laser beam L2 may be irradiated to a direction vertically striking the ground in FIG. 1 or to an opposite direction.

Furthermore, in one embodiment of the present invention, the plurality of nanoholes H1 may be disposed at positions corresponding to antinodes AN of the resonator internal field. Accordingly, the atoms A1 which have passed through the plurality of nanoholes H1 may be irradiated by the second laser beam L2 while passing through the antinode AN portion of the resonator internal field.

The first laser beam L1 generated by the first laser pump P1 may serve to induce the atom A1 into a state (overlapped state) in which the excited state and the ground state of the atom A1 overlap with the same (or substantially the same) probability. The second laser beam L2 generated by the second laser pump P2 may serve to maintain the dipole of the atom A1 in the internal space of the laser resonator C1. The second laser beam L2 may serve to maintain the quantum effect by continuously maintaining the dipole of the atom A1. At this time, when the second laser beam L2 is perpendicular to both of the traveling direction of the atom A1 and the axis of the laser resonator C1, and the atom A1 passes through the antinode AN portion of the resonator internal field, the effect caused by the second laser beam L2, that is, the dipole maintenance effect, etc. may be greatly improved. Meanwhile, all of the laser resonator C1, the atom A1, and the two laser beams L1, L2 may form (achieve) a resonance state (an optical resonance state).

When an atom A1 having the overlapped state by reacting with the first laser beam L1 enters the internal space of the laser resonator C1, a super-radiance effect may be generated in the resonator internal field, and a hyper-radiance effect may be created by reacting the atoms A1 with the second laser beam L2 in the resonator internal field. Accordingly, an emission laser L10 emitted from the laser resonator C1 may have an emission intensity larger than the emission intensity proportional to the square of the number of atoms A1 passing through the resonator internal field. In the hyper-radiance laser generation system according to the embodiment, since intensity component proportional to the cube of the number of atoms A1 passing through the resonator internal field is added, it is possible to generate a laser having an emission intensity significantly larger than that of existing super-radiance, that is, the emission laser L10. Here, the emitting laser L10 may be extracted in the axial direction of the laser resonator C1 through attenuation in the laser resonator C1 of the light resonating between the first and second mirror members M1 and M2. The emitting laser L10 may be extracted towards either the first and second mirror elements M1 and M2, for example towards the second mirror element M2. According to this embodiment, a hyper-radiance laser which exceeds the emission intensity of existing super-radiance lasers may be implemented.

In addition, according to an embodiment of the present invention, since a hyper-radiance system with a relatively simple configuration is used without using a trap for fixing atoms (materials) inside the laser resonator C1, there is an advantage that a technological implementation is simple. The hyper-radiance laser generation system according to the embodiment may be a type of a ‘microlaser system’, and the system may be one that does not fix the atoms A1 inside the laser resonator, but repeatedly shoots the atoms A1 in the form of a beam, reacts with the resonator internal field for a short period of time, and allows them to escape. Therefore, since there is no need to use a trap to fix atoms inside the resonator, technological implementation may be easy. In addition, according to an embodiment of the present invention, there is an advantage that a hyper-radiance laser may be implemented in a relatively simple manner through the addition and modification of simple configuration(s) in a device/system which applies an existing laser or super-radiance laser.

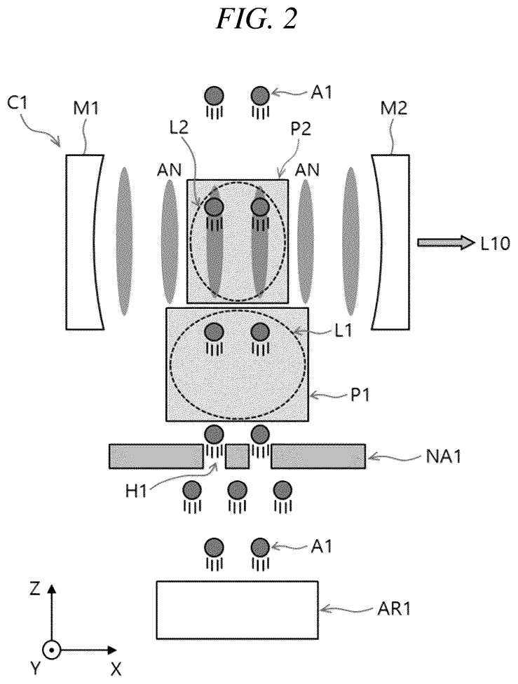

FIG. 2 is a diagram showing a hyper-radiance laser generation system according to another embodiment of the present invention.

Referring to FIG. 2, the hyper-radiance laser generation system according to this embodiment has a modified configuration based on the hyper-radiance laser generation system described with reference to FIG. 1. In the hyper-radiance laser generation system according to this embodiment, the first laser pump P1 may be configured to irradiate the first laser beam L1 between the nanohole defining member NA1 and the laser resonator C1. In other words, the first laser beam L1 may be irradiated to the plurality of atoms A1 between the nanohole defining member NA1 and the laser resonator C1. At this time, the first laser beam L1 may be irradiated to a direction perpendicular to the direction in which the plurality of atoms A1 travel, and may also be irradiated to a direction perpendicular to the axis of the laser resonator C1. In this case as well, the first laser beam L1 may serve to place (make) the atom A1 in a state where the excited state and the ground state overlap with the same (or substantially the same) probability. In some cases, the first laser beam L1 may partially overlap the mirror members M1 and M2 in the X-axis direction.

In the embodiment of FIG. 2, the gap between the nanohole defining member NA1 and the laser resonator C1 may be larger than the gap between the nanohole defining member NA1 and the laser resonator C1 in FIG. 1. Other configurations and functions may be the same or similar to those described with reference to FIG. 1.

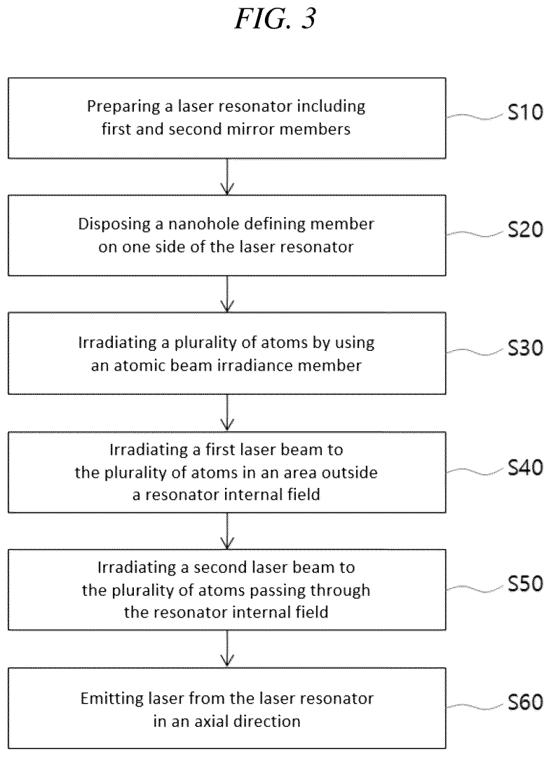

FIG. 3 is a flowchart for explaining a method for generating a hyper-radiance laser according to an embodiment of the present invention. The hyper-radiance laser generation method according to this embodiment may be a method for generating a hyper-radiance laser by using the system described with reference to FIGS. 1 and 2.

Referring to FIG. 3, the hyper-radiance laser generation method according to an embodiment of the present invention may include a step S10 for preparing a laser resonator including first and second mirror members arranged to face each other, a step S20 for disposing a nanohole defining member where a plurality of nanoholes opened toward an internal space between the first and second mirror members are formed on one side of the laser resonator, a step S30 for irradiating a plurality of atoms so that the plurality of atoms may pass through the plurality of nanoholes and into the internal space by using an atomic beam irradiance member disposed spaced apart from the laser resonator with the nanohole defining member interposed therebetween, a step S40 for irradiating a first laser beam to the plurality of atoms in any one of a region between the atomic beam irradiance member and the nanohole defining member and a region between the nanohole defining member and the laser resonator, a step S50 of irradiating a second laser beam to the plurality of atoms passing through a resonator internal field so as to overlap the resonator internal field formed between the first and second mirror members, and a step S60 for emitting the light which is resonating in the internal space of the laser resonator to an axial direction as a form of a laser. Here, the laser resonator, the nanohole defining member, the atomic beam irradiance member, the first laser beam, and the second laser beam may correspond to the laser resonator C1, the nanohole defining member NA1, the atomic beam irradiance member AR1, the first laser beam L1, and the second laser beam L2, respectively.

In the step S20, the plurality of nanoholes may be disposed at positions corresponding to antinodes of the resonator internal field.

In the step S30, the plurality of atoms may be irradiated to a direction perpendicular to the axis of the laser resonator as the form of a beam. In other words, in the step S30, an atomic beam having a resonance state with a resonator mode may be irradiated into the inside of the laser resonator in a direction perpendicular to the axis of the laser resonator.

In the step S40, the first laser beam may be irradiated to the plurality of atoms in an area outside the resonator internal field. For example, the first laser beam may be irradiated to the plurality of atoms between the atomic beam irradiance member and the nanohole defining member or between the nanohole defining member and the laser resonator. Here, the first laser beam may be irradiated to a direction perpendicular to the direction in which the plurality of atoms travel. Furthermore, the first laser beam may be irradiated to a direction perpendicular to the axis of the laser resonator. In addition, in the step S40, the intensity of the first laser beam may be adjusted so that the probability of existence of the ground state and the excited state of the atom may be equal (or substantially equal).

In the step S50, a center of the second laser beam may overlap with the resonator internal field. The second laser beam may be irradiated to a direction perpendicular to both of the direction in which the plurality of atoms travel and the axis of the laser resonator.

In the step S60, the light collected inside the laser resonator may be emitted as a form of a laser to the axial direction of the resonator through attenuation of the resonator. The laser (light) emitted in this way may be collected.

The steps S30, S40, and S50 may be performed simultaneously, step by step, or sequentially. In the step S40, the atoms may be in a state wherein an overlapping state in which the probability of existence of the ground state and the excited state is equal (substantially equal) by reacting with the first laser beam. When these atoms enter the internal space of the laser resonator, a super-radiance effect may be generated in the resonator internal field. In the step S50, the atoms may react with the resonator internal field in the resonator internal field, and react with the second laser beam to emit light. As a result, a hyper-radiance effect may be created. Accordingly, the emitting laser emitted from the laser resonator may have an emission intensity larger than the emission intensity proportional to the square of the number of atoms passing through the resonator internal field.

In addition, the features, functions, effects, etc. related to the laser resonator, the nanohole defining member, the atomic beam irradiance member, the first laser beam, and the second laser beam may be the same as those described with reference to FIGS. 1 and 2.

The hyper-radiance laser generation system and hyper-radiance laser generation method according to embodiments of the present invention may be usefully applied to various fields such as quantum information, optical communication, laser processing, and so on which require high-efficiency, high-output lasers. Furthermore, the hyper-radiance laser generation system and hyper-radiance laser generation method according to embodiments may be applied to the field of LED (light emitting device) to develop a brighter and more efficient light source. In addition, since the embodiments of the present invention may easily implement light emission in the visible light region by selecting appropriate types of atoms and resonator structures, the systems and methods according to the embodiments may also be usefully applied in the field of optical communication using visible light.

Below, theoretical research results and simulation data related to the present invention will be described.

In embodiments of the present invention, the degree of hyper-radiance may be characterized by R, which is a normalized radiance witness. The R may be defined as Equation 1 below.

$$R = \frac{{〈 \hat{n} 〉}_{2} - 2 {〈 \hat{n} 〉}_{1}}{2 {〈 \hat{n} 〉}_{1}} \qquad [ Equation 1 ]$$

In Equation 1, [symbol] \hat{n} [symbol] ₁ represents the average photon number in a steady state for the one-atom case (N=1). In other words, [symbol] \hat{n} [symbol] ₁ represents the average number of photons when atoms enter the resonator internal field one by one on average during a certain time. Meanwhile, [symbol] \hat{n} [symbol] ₂ represents the average photon number in a steady state for the two-atom case (N=2). In other words, [symbol] \hat{n} [symbol] ₂ represents the average number of photons when, on average, two atoms enter the resonator internal field on average during a certain time. Meanwhile, the above-mentioned N represents the number of atoms interacting with the resonator (laser resonator) at the same time.

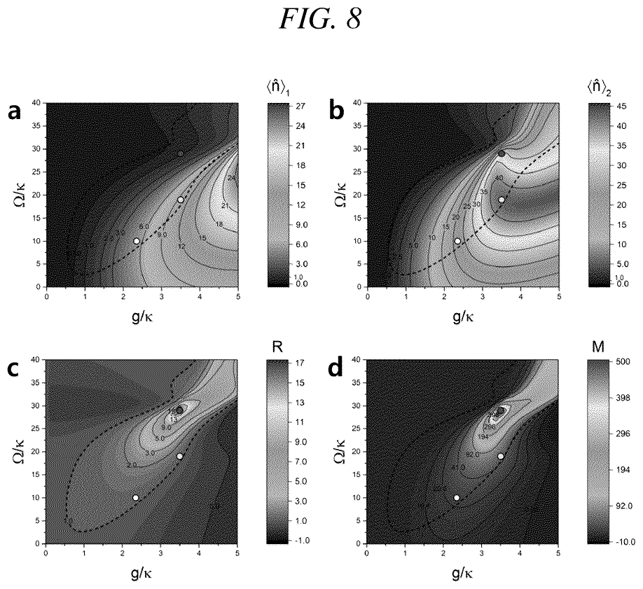

In the case of a super-radiance laser, since it exhibits an emission intensity proportional to N², [symbol] \hat{n} [symbol] ₂ is 4 times [symbol] \hat{n} [symbol] ₁ and the value of R becomes 1. Therefore, if the R value is larger than 1 (i.e., R>1), it may be said to correspond to hyper-radiance which exceeds the hyper-radiance limit. In the case of a hyper-radiance laser, [symbol] \hat{n} [symbol] ₂ is larger than 4 times [symbol] \hat{n} [symbol] ₁ and yields an R value larger than 1. In the case of an embodiment of the present invention, the R value may be increased to about 17 or more, as shown in FIG. 8(c), which will be described later. When the R value is 17, based on Equation 1 above, [symbol] \hat{n} [symbol] ₂ may be 36 times [symbol] \hat{n} [symbol] ₁. Therefore, the hyper-radiance laser generation system according to an embodiment of the present invention may generate a laser having a tremendously high emission intensity which exceeds the limits of existing super-radiance lasers.

Meanwhile, in connection with the embodiment of the present invention, the following Equation 2 may be obtained for specific conditions.

$$\begin{matrix}n \approx {[ \frac{- 3 + 4 N ( Ω / κ ) {( g τ )}^{2} + \sqrt{9 - 24 N ( Ω / κ ) {( g τ )}^{2} + 24 {{N}^{2} ( g / κ )}^{2} {( g τ )}^{2}}}{4 N ( g / κ ) {( g τ )}^{2}} ]}^{2} \\ \approx {{( \frac{g N}{κ} )}^{2} [ 1 - \frac{2}{3} {( Ω τ )}^{2} + \frac{4}{3} N ( Ω / κ ) {( g τ )}^{2} - \frac{2}{3} {{N}^{2} ( g / κ )}^{2} {( g τ )}^{2} ]}^{2}\end{matrix} \qquad [ Equation 2 ]$$

In Equation 2, n corresponds to the square of the absolute value of a (i.e., n=|α|²). â represents the annihilation operator for the resonator field (i.e., the resonator internal field), and the expectation value of a quantum operator such as â may be approximated by a classical quantity, α. Ω represents the Rabi frequency (Rabi frequency) of the second pump laser, that is, the second laser beam. κ refers to the attenuation rate of the resonator. In another aspect, κ refers to the reciprocal of the cavity decay time. g represents the coupling strength between the atom and the resonator field (i.e., the resonator internal field). When an atom passes through the antinode of a resonator mode, it may interact with the resonator field (i.e., the resonator internal field) with maximum coupling strength. τ represents interaction time. In other words, τ means the time an atom stays within the resonator field (i.e., the resonator internal field).

From Equation 2, the value of n not only may include an operation term corresponding to N², but also further include an operation term corresponding to N³, and an operation term larger than N³, etc. This may be said to be at least partially a result of the action of the first pump laser (i.e., the first laser beam) and the second pump laser (i.e., the second laser beam). Therefore, in the hyper-radiance laser generation system according to the embodiment, an intensity component proportional to the cube of the number of atoms may be added to generate a laser with an emission intensity remarkably larger than that of the existing super-radiance.

In addition, in connection with the theoretical studies and the mathematical calculations applied to the hyper-radiance laser generation system and hyper-radiance laser generation method according to embodiments of the present invention, you may be refer to the disclosure of “Scientific Reports 11, 11256 (2021),” a paper published by the inventor of the present invention, and the disclosure of this paper is incorporated herein by reference in its entirety.

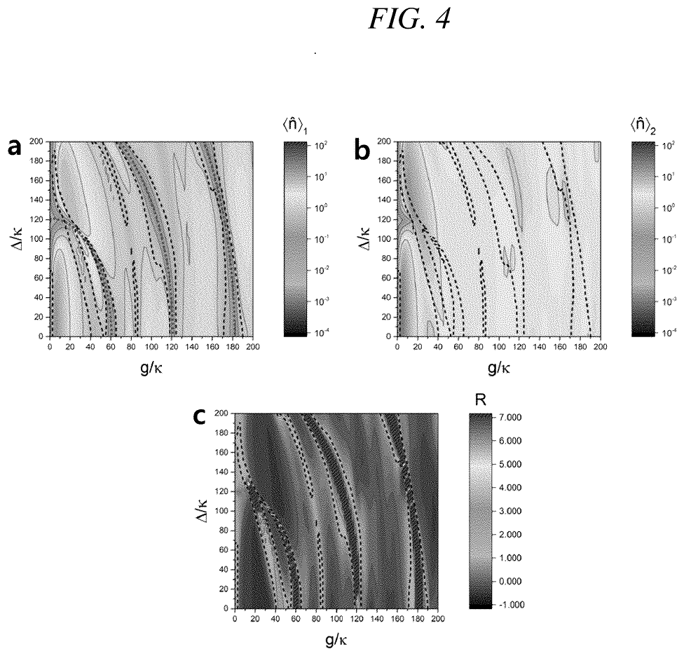

FIG. 4 is a graph showing simulation results evaluating the dependence of hyper-radiance on g/κ and Δ/κ in a hyper-radiance laser generation system according to an embodiment of the present invention. (a) drawing shows the average number of photons in the resonator of the one-atom case, (b) drawing shows the average number of photons in the resonator of the two-atom case, and (c) drawing shows the R value which is the radiance witness. Here, Δ may correspond to the value obtained by subtracting the cavity resonant frequency (ω_{c}) from the atomic transition frequency (ωₐ). Furthermore, A may correspond to the value obtained by subtracting the frequency (ωₐ) of the first pump laser (i.e., the first laser beam) from the atomic transition frequency (ωₐ). Furthermore, A may correspond to the value obtained by subtracting the frequency (ωₚ₂) of the second pump laser (i.e., the second laser beam) from the atomic transition frequency (ωₐ).

Referring to (c) of FIG. 4, the hatched red area may be an area where the R value is larger than 7. Here, the Rabi frequency may be Ω/κ, and its value may be 10. Interaction time (τ) may be 0.052/κ, cavity decay time (1/κ) may be 1.93 μs, and ϕ may be π/2. Here, ϕ refers to the constant phase introduced by the first pump laser (i.e., the first laser beam). The area inside the black dotted curves corresponds to the hyper-radial area.

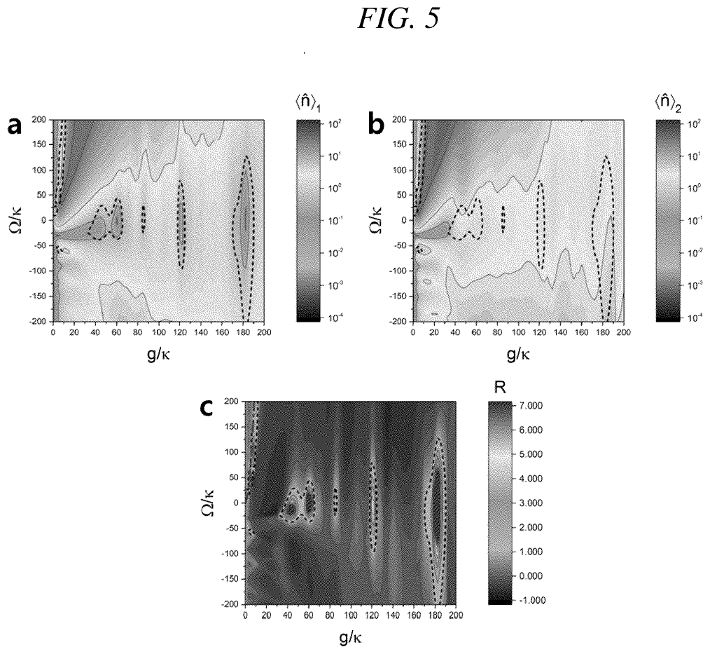

FIG. 5 is a graph showing simulation results evaluating the dependence of hyper-radiance on g/κ and Ω/κ in a hyper-radiance laser generation system according to an embodiment of the present invention. (a) drawing shows the average number of photons in the resonator of the one-atom case, (b) drawing shows the average number of photons in the resonator of the two-atom case, and (c) drawing shows the R value which is the radiance witness.

Referring to (c) of FIG. 5, the hatched red area may be an area where the R value is larger than 7. Here, interaction time (τ) may be 0.052/κ, cavity decay time (1/κ) may be 1.93 μs, and ϕ may be π/2. A resonance case (Δ=0) that satisfies these conditions was assumed. The area inside the black dotted curves corresponds to the hyper-radial area.

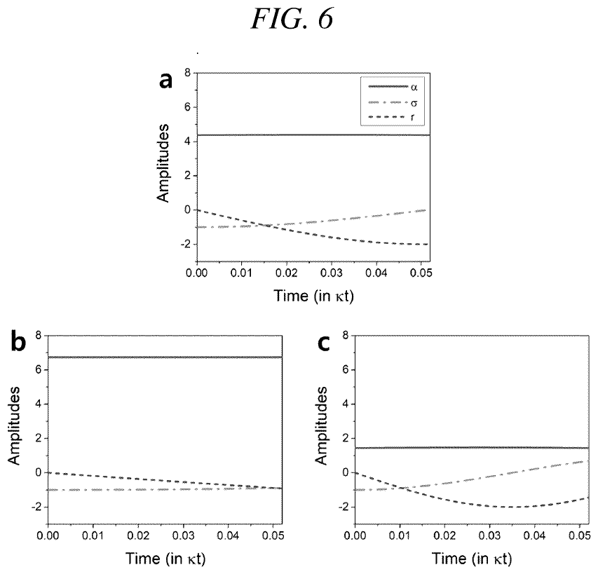

FIG. 6 is a graph showing an origin of hyper-radiance with regard to resonance that may be obtained in connection with a hyper-radiance laser generation system according to an embodiment of the present invention. α, σ, and r values were evaluated during the atom-cavity(resonator) interaction time. (a) drawing shows the results evaluated during the atom-cavity interaction time (τ) corresponding to κτ=0.052 when Ω=0, g/κ=3.5, and N=2. (b) drawing shows the results evaluated during the atom-cavity interaction time (i) corresponding to κτT=0.052 when Ω/κ=19. (c) drawing shows the results evaluated during the atom-cavity interaction time (τ) corresponding to κτ=0.052 when Ω/κ=−19. â is the annihilation operator for the resonator field (i.e., resonator internal field), \hat{σ}ᵢ⁻ is the lowering operator for the ith two-level atom, and \hat{σ}_{zi} is the Pauli z-matrix. The expectation values of quantum operators such as â, \hat{σ}ᵢ⁻ and \hat{σ}_{zi} may be approximated by classical quantities α, σ, and r, respectively.

Referring to FIG. 6, when Ω>0 [i.e., (b) drawing], the change in a may be minimized and remain close to its initial value, and therefore, atomic polarization may be maximized and |α| increases. On the other hand, when Ω<0 [i.e., (c) drawing], a may change more than a case that Ω=0 [i.e., (a) drawing], atomic polarization may be minimized, and |α| has a low value.

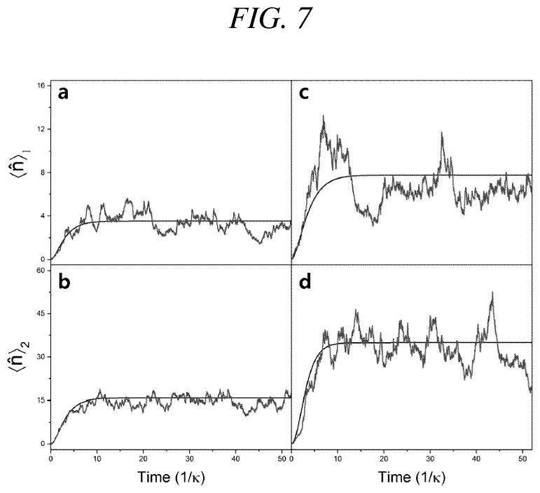

FIG. 7 is a graph evaluating the change in average photon number inside the resonator that may be obtained from a hyper-radiance laser generation system according to an embodiment of the present invention. (a) drawing shows the results for the one-atom case when g/κ=2, Δ/κ=2 and Ω/κ=10, and (b) drawing shows the results for g/κ=2, Δ/κ=2 and Ω/κ=10, the results for the two-atom case are shown. (c) drawing shows the results for the one-atom case when g/κ=3, Δ/κ=0 and Ω/κ=15, and (d) drawing shows the results for the two-atom case when g/κ=3, Δ/κ=0 and Ω/κ=15. Furthermore, in (a) to (d) drawings, the black curve shows the ideal result for the regular injection case (i.e., ideal conditions) of atoms, and the red curve shows the result for the random injection case of atoms. At this time, it was assumed that interaction time (τ)=0.052/κ, cavity decay time (1/κ)=1.93 μs, and ϕ=π/2. The unit time of the time scale (i.e., 1/κ) is 1.93 μs.

Referring to FIG. 7, it may be seen that the average value of the red curve in each graph follows similarly to the black curve. This means that even in the random injection case, the results are similar to the ideal results in the regular injection case. Therefore, even if atoms are introduced (injected) relatively randomly or somewhat irregularly into the internal space of the laser resonator, the results similar to the ideal case may be achieved on average.

FIG. 8 is a graph showing simulation results evaluating whether or not hyper-radiance exists for a hyper-radiance laser generation system according to an embodiment of the present invention. (a) and (b) drawings show the emission intensity of the laser, (c) drawing shows the R value indicating hyper radiance, and (d) drawing shows the M value corresponding to the efficiency coefficient. The (a) drawing shows the average number of photons in the resonator (cavity) in the one-atom case, and (b) drawing shows the average number of photons in the resonator (cavity) in the two-atom case. (c) drawing shows the results of evaluating the R value as described in Equation 1 above. At this time, τ=0.052/κ, 1/κ=1.93 μs, and ϕ=π/2. (d) drawing shows the M value multiplied by the values in (b) and (c).

Referring to FIG. 8, (a) drawing shows the results showing the emission intensity in terms of the number of photons inside the resonator when inserting atoms one by one into the resonator at a constant rate, and (b) drawing shows the emission intensity when inserting atoms two by two at a constant rate. The variables which make up the graph are variables expressed as a ratio of the intensity (Ω) of the second pump laser (i.e., the second laser beam) entering the inside of the resonator and the coupling constant (g) between the atom and the resonator for the attenuation rate (κ) of the resonator.

The R value in (c) drawing is a number which compares the results of inserting two atoms and one atom, and corresponds to the value obtained by dividing the result obtained when inserting two atoms by twice the result obtained when inserting atoms one by one, and then subtracting 1. In the case of hyper-radiance, when two atoms are put in, more than four times as much as when put in one by one must be obtained, so the R value must exceed 1. In (c) drawing, it may be confirmed that the R value increases beyond 1 to 17 or more.

The M value depicted in the (d) drawing is the product of the R value and the emission intensity when inserting atoms by two, and is a quantity defined to find an efficient region where both of the R value and the emission intensity are strong. In (d) drawing, the black dotted line represents the area where R=1, and the inside area thereof corresponds to the hyper area. In the area where g/κ=3.5 and Ω/κ=30, it was confirmed that an area where the emission intensity was 30, the R value was about 16, and the M value was high at about 480 exists.

Referring again to (c) of FIG. 8, according to an embodiment of the present invention, the R value may be increased to about 17 or more. When the R value is 17, based on Equation 1 above, [symbol] \hat{n} [symbol] ₂ may be 36 times of [symbol] \hat{n} [symbol] ₁. In this embodiment, in the case of the two-atom case with [symbol] \hat{n} [symbol] ₁=9.78, Ω/r=19, and g/κ=3.5, the maximum mean photon number ( [symbol] \hat{n} [symbol] ₂) of about 43 was obtained. Therefore, the hyper-radiance laser generation system according to an embodiment of the present invention may generate a laser with a remarkably high emission intensity which exceeds the limits of existing super-radiance lasers.

According to the embodiments of the present invention described above, a hyper-radiance laser generation system having an emission intensity larger than the emission intensity proportional to the square of the number of atoms may be implemented. In the hyper-radiance laser generation system according to the embodiment, an intensity component proportional to the cube of the number of atoms is added to generate a laser with an emission intensity tremendously larger than that of the existing super-radiance. In addition, according to embodiments of the present invention, there is an advantage in that technological implementation is easy because a hyper-radiance system with a relatively simple structure is used without using a trap for fixing atoms inside the laser resonator. In addition, there is an advantage that hyper-radiance may be implemented in a relatively simple manner through the addition and modification of simple configuration(s) in a device/system that applies an existing laser or super-radiance laser.

The hyper-radiance laser generation system and hyper-radiance laser generation method according to these embodiments may be usefully applied to various fields which require high-efficiency, high-output lasers, such as quantum information, optical communication, laser processing, or military fields. Furthermore, the hyper-radiance laser generation system and hyper-radiance laser generation method according to embodiments may be applied to the field of LED (light emitting device) to develop a brighter and more efficient light source. In addition, since the embodiments of the present invention may easily implement light emission in the visible light region by selecting appropriate types of atoms and resonator structures, the systems and methods according to the embodiments may also be usefully applied to the field of optical communication using visible light.

In this specification, the preferred embodiments of the present invention have been disclosed, and although specific terms have been used, they are only used in a general sense to easily explain the technical content of the present invention and to help understanding the present invention, and they are not used to limit the scope of the present invention. It is obvious to those having ordinary skill in the related art to which the present invention belong that other modifications based on the technical idea of the present invention can be implemented in addition to the embodiments disclosed herein. It will be understood to those having ordinary skill in the related art that in connection with hyper-radiance laser generation systems and hyper-radiance laser generation methods according to the embodiments described with reference to FIGS. 1 to 8, various substitutions, changes, and modifications may be made without departing from the technical spirit of the present invention. Therefore, the scope of the invention should not be determined by the described embodiments, but should be determined by the technical concepts described in the claims.

The hyper-radiance laser generation systems and hyper-radiance laser generation methods according to embodiments of the present disclosure may be applied to fields such as quantum information, optical communication, laser processing, and so on that require a laser generator and a high-efficiency/high-output laser.

What is claimed is:

1. A hyper-radiance laser generation system comprising:
a laser resonator including first and second mirror members arranged to face each other;
a nanohole defining member disposed on one side of the laser resonator and where at least one nanohole opened toward an internal space between the first and second mirror members is formed;
an atomic beam irradiance member which irradiates a plurality of atoms so that they pass through the nanohole and into the internal space;
a first laser pump which generates a first laser beam to be irradiated to the plurality of atoms in any one of a region between the atomic beam irradiance member and the nanohole defining member, and a region between the nanohole defining member and the laser resonator; and
a second laser pump which generates a second laser beam that overlaps with a resonator internal field formed between the first and second mirror members and is irradiated to the plurality of atoms passing through the resonator internal field.

2. The hyper-radiance laser generation system of claim 1, wherein the laser resonator, the first laser beam, and the second laser beam achieve a resonance state.

3. The hyper-radiance laser generation system of claim 1, wherein a center of the second laser beam overlaps with the resonator internal field.

4. The hyper-radiance laser generation system of claim 1, wherein the plurality of atoms are irradiated to a direction perpendicular to an axis of the laser resonator.

5. The hyper-radiance laser generation system of claim 1, wherein the first laser beam is irradiated to a direction perpendicular to a direction in which the plurality of atoms travel.

6. The hyper-radiance laser generation system of claim 1, wherein the second laser beam is irradiated to a direction perpendicular to both of a direction in which the plurality of atoms travel, and an axis of the laser resonator.

7. The hyper-radiance laser generation system of claim 1, wherein the nanohole is disposed at a position corresponding to an antinode of the resonator internal field.

8. The hyper-radiance laser generation system of claim 1, wherein the first laser pump is provided to irradiate the first laser beam between the atomic beam irradiance member and the nanohole defining member.

9. The hyper-radiance laser generation system of claim 1, wherein the first laser pump may be provided to irradiate the first laser beam between the nanohole defining member and the laser resonator.

10. The hyper-radiance laser generation system of claim 1, wherein an emitting laser emitted from the laser resonator has an emission intensity larger than an emission intensity proportional to a square of a number of atoms passing through the resonator internal field.

11. A method for generating a hyper-radiance laser comprising:
preparing a laser resonator including first and second mirror members arranged to face each other;
disposing a nanohole defining member having at least one nanohole opened toward an internal space between the first and second mirror members on one side of the laser resonator;
irradiating a plurality of atoms so that they pass through the nanohole into the internal space by using an atomic beam irradiance member disposed spaced apart from the laser resonator with the nanohole defining member interposed therebetween;
irradiating a first laser beam to the plurality of atoms in any one of a region between the atomic beam irradiance member and the nanohole defining member, and a region between the nanohole defining member and the laser resonator;
irradiating a second laser beam to the plurality of atoms passing through a resonator internal field so as to overlap the resonator internal field formed between the first and second mirror members; and
emitting light resonating in the internal space of the laser resonator in an axial direction of the laser resonator as a form of a laser.

12. The method for generating a hyper-radiance laser of claim 11, wherein the laser resonator, the first laser beam, and the second laser beam achieve a resonance state.

13. The method for generating a hyper-radiance laser of claim 11, wherein a center of the second laser beam overlaps with the resonator internal field.

14. The method for generating a hyper-radiance laser of claim 11, wherein the plurality of atoms are irradiated to a direction perpendicular to an axis of the laser resonator.

15. The method for generating a hyper-radiance laser of claim 11, wherein the first laser beam is irradiated to a direction perpendicular to a direction in which the plurality of atoms travel.

16. The method for generating a hyper-radiance laser of claim 11, wherein the second laser beam is irradiated to a direction perpendicular to both of a direction in which the plurality of atoms travel, and an axis of the laser resonator.

17. The method for generating a hyper-radiance laser of claim 11, wherein the nanohole is disposed at a position corresponding to an antinode of the resonator internal field.
